(19) United States
(12) Patent Application Publication
(10) Pub. No.: US 2006/0119621 A1
(43) Pub. Date: Jun. 8, 2006

(54) Method and device for displaying medical patient data on a medical display unit

(76) Inventor: Claude Krier, Stuttgart (DE)

Correspondence Address: ST. ONGE STEWARD JOHNSTON & REENS, LLC, 986 BEDFORD STREET, STAMFORD, CT, 06905-5619, US

(21) Appl. No.: 11/291,144

(22) Filed: Nov. 30, 2005

Related U.S. Application Data
(63) Continuation of application No. PCT/EP04/05819, filed on May 28, 2004.

(30) Foreign Application Priority Data
May 30, 2003 (DE) 103 25 382.3

(51) Int. Cl. G09G 5/00

(52) U.S. Cl. 345/629

(57) ABSTRACT

An apparatus for displaying medial patient data has a first signal source for generating a first video signal for outputting on a display screen. The video signal contains image data for a first image foreground and a first image background, with the image foreground representing a first set of medical patient data. The apparatus also has a second image source for generating a second video signal. The second video signal represents a second set of medical patient data. A video signal superimposition unit is configured to superimpose the first and second video signals in a manner such that the image data from the first image background is overwritten with image data from the second video signal.

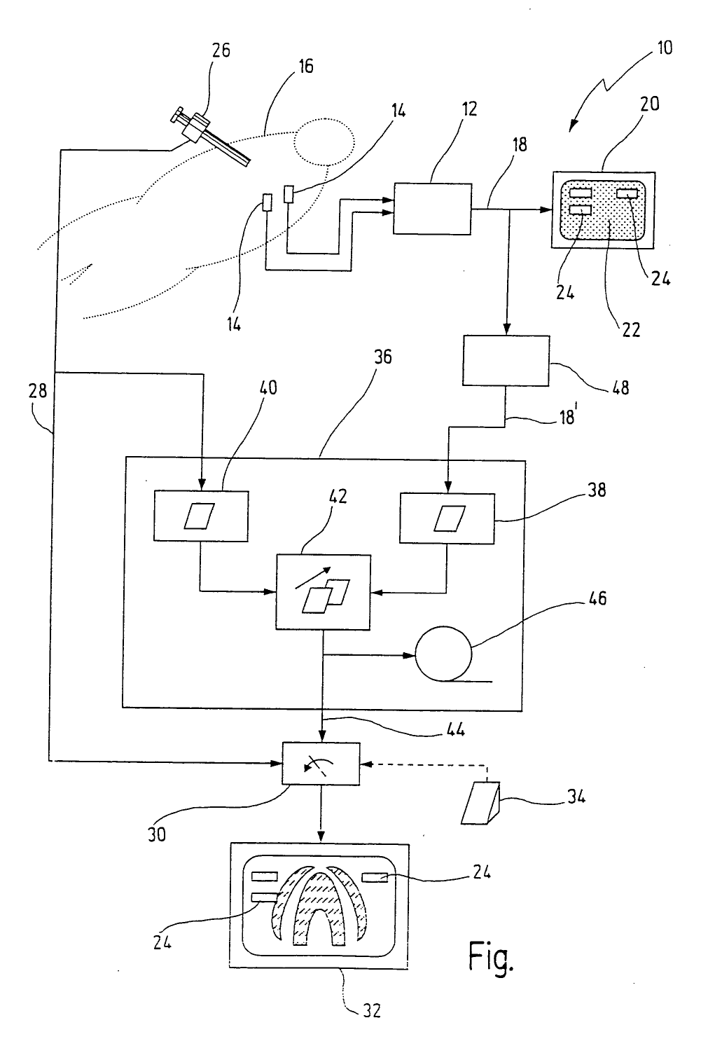

### CROSS-REFERENCE TO RELATED APPLICATIONS

This application is a continuation of international patent application PCT/EP2004/005819 filed on May 28, 2004 and published in German language as WO 2004/107740 A, which international application claims priority under the Paris convention from German patent application DE 103 25 382.3 filed on May 30, 2003.

### BACKGROUND OF THE INVENTION

The present invention relates to a method and an apparatus for displaying medical patient data on a medical display unit. More particularly, it relates to a method and an apparatus for simultaneous display of physiological measurement data which has been recorded on the body of a patient, and of camera images of the patient or body parts of the patient. Preferred fields of use for the new method and the corresponding apparatus are fiber-optic intubation of patients, both planned and in an emergency, intensive care bronchoscopy, bronchial lavage of a patient and other endoscopic interventions which are carried out with visual monitoring on the one hand and with continuous recording of measured values on the other hand, for example breathing gas parameters.

In the field of modern medicine, it is known for medical interventions to be monitored and carried out visually on the basis of (live) images. The (live) images are normally displayed to the doctor carrying out the treatment, on a display screen. This applies in particular to minimal-invasive interventions, but also to visual monitoring of intubations and the like. A control center for such kind of medical treatment of a patient is known, for example, from U.S. Pat. No. 5,778,688, which is incorporated by reference herein.

From medical treatment of patients, it is furthermore known that physiological measurement values of a patient, which are determined by means of suitable measurement systems, are displayed to the doctor carrying out the treatment on a display screen. In many cases, this comprises the graphical display of measurement curves and/or the numerical display of measured values, such as heart rates, breathing gas parameters or blood values. By way of example, reference is made to the “IntelliVue” patient monitoring system from the Philips Company.

The large amount of patient data that is available in each specific case, irrespective of whether this is live or archive images recorded using a camera or numerical measured values, must be presented to the doctor carrying out the treatment in as clear a form as possible in order to allow optimum treatment of the patient. Since, on the other hand, the doctor has to carry out interventions on the patient on the basis of the available patient data, his freedom of movement and his flexibility are often restricted. It is therefore desirable to display a large amount of patient data in as compact a form as possible and on the other hand variably on a display screen. For this purpose, it is necessary to combine the various patient data items, which in general originate from different sources, with one another in such a way that these items can be output on the display screen. Difficulties occur when a large amount of changing patient data, for example depending on the field of use and the specific treatment, have to be combined, since a considerable amount of control and processing effort is required to take account of the various data sources and the desired variation options.

Additional difficulties occur when patient data acquisition systems from different manufacturers are intended to be combined with one another since, in this case, complex matching and/or considerable adaptation effort are required for signal matching, signal conversion, data conditioning, etc. Approaches that have been practiced in the past are generally based on using a control computer to condition the patient data from the various sources and to combine such data to form the desired combined output image. Because of the difficulties mentioned above, the amount of effort is in this case relatively large in practice, and the flexibility for choice of the display parameters is restricted.

### SUMMARY OF THE INVENTION

Against this background, it is an object of the invention to specify a method and an apparatus for combining medical patient data from different sources easily and with as much flexibility as possible to form a common display image.

According to one aspect, there is provided a method for displaying medical patient data on a medical display unit having a display screen, the method comprising the steps of: providing a first video signal which is adapted to be output on the display screen and which contains image data for a first image foreground and a first image background, with the first image foreground representing a first set of medical patient data, providing a second video signal which is adapted to be output on the display screen and which contains image data representing a second set of medical patient data, superimposing the first and second video signals to produce a superimposed video signal, with the image data from the first image background being overwritten with image data from the second video signal in the superimposed video signal, and outputting the superimposed video signal on the display screen.

According to another aspect, there is provided an apparatus for displaying medical patient data, comprising a display unit, a first image source for producing a first video signal adapted to be output on the display unit, the first video signal containing first image data for a first image foreground and first image background, with the first image foreground representing a first set of medical patient data, a second image source for producing a second video signal adapted to be output on the display unit, the second video signal containing second image data representing a second set of medical patient data, a video signal superimposition unit for superimposing the first and second video signals in order to produce a superimposed video signal, with the video signal superimposition unit being designed such that the image data from the first image background is overwritten with image data from the second video signal, the display unit being configured to output the superimposed video signal.

The new method and apparatus are based on the idea of not combining the various patient data items until a very late time in the signal conditioning process to form the overall screen content. More particularly, the patient data from the various data sources should initially be conditioned on its own in a form which allows it to be output on a display screen. The patient data from the various sources are thus provided in the form of video signals, and the final combination is carried out only by superimposing the individual video signals. In contrast to this, the production of output-compatible video signals has until now been carried out only when the patient data from the various sources had already been combined with one another or integrated in one another.

The superimposition of video signals is carried out using a different approach, which is known per se from the field of film and television technology, or from computer graphics production. The overlay of an image on another image has already been known for a long time from the field of television, under the keyword “Blue screen”. Furthermore, this method is also used in the production of fast video sequences for computer games and the like. The fundamental idea here is to define the background of the first image as being invisible and to superimpose a second image on the first image then. This results in foreground objects from the first image being displayed over the second image, which itself represents a common image background. The first image background can be “made invisible” in a simple manner by using the background color of the first image as a decision criterion to determine whether a specific pixel in the superimposed overall image is intended to be defined by the color values of the first image or of the second image. This procedure is also known by the keywords “color keying” or “chroma keying” in image processing.

In other words, the present invention makes use of the color keying technique, which is known per se, for integration of medical patient data from different sources to form a combined display image. This new concept has the advantage that patient data items from different sources and, in particular, from mutually incompatible systems, can be combined with one another very easily without having to adopt complex adaptation and conversion measures. Furthermore, this allows to exploit and retain the flexibility of available data sources very easily. There is no need for complex integration of data as a function of variable parameters and, as a consequence of this, the new concept can also be implemented very quickly in practice.

On the other hand, the new concept offers the capability to display patient data from different data sources jointly on a single display unit, so that the doctor carrying out the treatment is provided with one compact and central information source. The above-mentioned object is thus completely achieved.

In a refinement of the invention, the second video signal is provided as an output signal from a camera, more preferably as an output signal from an endoscopic camera.

The advantages of the new concept, as mentioned above, are even more evident in this case, since camera images on the one hand include an enormous amount of data, which results in a considerable amount of processing effort for conventional integration of image data from different sources. On the other hand, camera images are a very important data source in the field of modern medical treatment. Furthermore, the high degree of flexibility and adaptation capability which the new concept allows even without complex integration measures, especially for live images, such as those which are produced in particular by endoscopic cameras, are of major importance. For the sake of completeness, however, it should be noted that this refinement of the new concept is not restricted to moving live images, but also offers major advantages for still images and/or archive images. Furthermore, it should be noted that, for the purposes of this refinement, the term endoscopic camera means any type of image recording unit which is designed to produce images from inside the body of a patient. It may thus, for example, be a camera attachment to a traditional endoscope, or a CCD or CMOS miniature camera, which is inserted into the patient's body using suitable means.

In a further refinement, the first video signal is produced as an output signal from a measurement data system for recording and/or administration of preferably physiological measurement data of a patient.

This refinement is particularly advantageous in conjunction with the above-mentioned measure, although it can also be implemented independently. The combination of physiological measurement data with live images from a camera represents a particularly effective means, however, for displaying virtually all patient data, which is significant for a treatment, in a compact and centralized form to a doctor carrying out the treatment. Furthermore, measurement data which is generally displayed in the form of numerical values and/or measurement curves can be combined very well with camera images to form a superimposed display image, since the structural differences between these data sources influence or disturb one another only to a minor extent.

In a further refinement, the first and the second video signals are produced in a unified format, in particular as S-VHS signals. A video signal converter is preferably provided in the corresponding apparatus and converts at least one of the video signals to a predetermined signal format, preferably to an S-VHS signal.

This measure again is advantageous in situations in which live images from a camera are (also) intended to be displayed, since these are particularly suitable for being displayed by means of an S-VHS signal. On the other hand, numerical data and/or measurement curves can also be displayed well on a screen by means of an S-VHS signal. The use of unified signal formats further has the advantage that the complexity and processing time for combination of the various patient data items are reduced. The combined image can thus be displayed more easily, at a lower cost and more quickly.

In a further refinement, the superimposed video signal is output on the medical display unit in a first operating mode, and only the second video signal is output in a second operating mode, with the second operating mode preferably being a standard operating mode, and the first operating mode being selectable by choice.

Accordingly, a preferred refinement of the apparatus has at least a first and a second signal input on the display unit, and has a selection switch for switching between the first and the second signal input, with the superimposed video signal being supplied to the first signal input, and the second video signal being supplied to the second signal input.

This refinement again is particularly advantageous when the second video signal is obtained from a camera source, because this refinement means that the camera image is generally visible and can be displayed free of superimpositions, without any problems, by operation in the standard operating mode. The overlaying of numerical or graphical patient data can thus be activated or deactivated in a very simple and low-cost manner. Furthermore, this refinement has the advantage that the visual monitoring, which is more important in the case of doubt, allows emergency operation, for example intubation of a patient, without first of all having to start up the entire system. Quicker patient treatment is thus possible in critical situations.

In a further refinement, at least one of the video signals is produced as a digital video signal.

This measure simplifies the practical implementation of the new concept, since algorithms for digital color keying are already available from other fields of application. The provision of digital video signals makes these options directly usable and means that there is no need for so-called frame grabber components for digitization of analog video signals. However, in principle, the superimposition of said video signals can also be carried out in a completely analog form.

It goes without saying that the features mentioned above and those which are still to be explained in the following text can be used not only in the respectively stated combination but also in other combinations or on their own without departing from the scope of the present invention.

### BRIEF DESCRIPTION OF THE DRAWINGS

Exemplary embodiments of the invention are illustrated in the drawing and will be explained in more detail in the following description. An apparatus based on the new concept is shon in the single FIGURE.

### DESCRIPTION OF PREFERRED EMBODIMENTS

According to a preferred exemplary embodiment, an apparatus 10 has a measurement data acquisition unit 12, which records and conditions the measurement signals from one or more sensors 14. The sensors 14 supply, for example, measurement signals for determination of the heart rate of a patient 16, breathing path parameters and/or blood values. The nature of the sensors 14 and the nature of the individual measured values should, however, be regarded as of secondary importance, and accordingly in fact as examples, for the practical implementation of the new concept.

At its output, the measurement data acquisition unit 12 produces a first video signal 18, which is designed to produce a display of the recorded measurement data on a display screen 20. In one exemplary embodiment, which is currently undergoing practical trials, the measurement data acquisition unit 12 produces an SVGA signal, which is displayed on display screen 20. However, the invention is not restricted to this type of signal and can likewise be used with other video signals, in particular digital video signals. Since the patient data supplied from the measurement data acquisition unit 12 is primarily in the form of data which can be displayed numerically and/or graphically, the video signal 18 in this case includes image data which produces an image background 22 and an image foreground with the patient data 24 to be displayed, on the screen 20. By way of example, the patient data 24 in this case comprises a numerical display of the physiological measurement data for the patient 16.

In the exemplary embodiment which is currently undergoing trials, the measurement data acquisition unit 12 and the display screen 20 are components of the IntelliVue patient monitoring system from the Philips Company. Specifically, the screen 20 is a Type MP90 screen from the Philips range that has been mentioned.

Reference number 26 denotes an endoscopic camera which, in the exemplary embodiment which is undergoing trials, is a Telecam or Tricam from the applicant of the present invention. The camera 26 produces a second video signal 28, which is an S-VHS signal in the present exemplary embodiment. The second video signal 28 is in this case supplied via a signal changeover switch 30 to a second screen 32, and can be displayed directly on it. Reference number 34 denotes a foot-operated switch, which is used here to operate the signal changeover switch 30. The foot-operated switch 34 can be operated by the doctor carrying out the treatment in order to switch between the direct S-VHS video signal 28 and the video signal combined in the manner which will be explained in more detail in the following text.

Reference number 36 denotes a video superimposition unit which, in this specific case, is in the form of a standard PC. The standard PC 36 is, however, provided with two frame grabber cards 38, 40 for use within the apparatus 10, by means of which the first video signal 18 and the second video signal 28 are recorded and digitized. The processor in the standard PC 36 is indicated schematically by reference number 42. The processor 32 is suitably programmed to superimpose the first and the second video signals 18, 28, as is illustrated symbolically in the FIGURE. Specifically, the processor 42 carries out a color keying process, as is already known per se from the field of graphics processing on Windows-based systems. The image background 22 in the image data of the first video signal 18 is in this case defined to be transparent, and is replaced by image data from the second video signal 28. Apart from this, the image data from the first video signal 18 is retained, that is to say the image foreground of the first video signal also forms an image foreground in the combined video signal 44.

The processor 42 thus produces a superimposed video signal 44, which is supplied on the one hand to the signal changeover switch 30 and in this case, additionally to an image data memory 46 as well. The image date memory 46 is here used for archiving and for subsequent documentation of the treatment carried out.

Reference number 48 denotes a signal converter, which is connected between the output of the measurement data acquisition unit 12 and the frame grabber card 38 in the video superimposition unit 36. The signal converter 48 converts the SVGA signal from the measurement data acquisition unit 12 to an S-VHS signal 18′, so that the first and the second video signal can be recorded by the video superimposition unit 36 in the same signal format.

As is illustrated schematically on display screen 32, the superimposed video signal 44 results in a display in which the video image recorded by the camera 26 has the patient data 24 superimposed on it. The doctor carrying out the treatment thus has the option to view both the numerical patient data 24 and the video image recorded by the camera 26. The screen 32 is preferably arranged in the immediate working area and field of view of the doctor carrying out the treatment (not illustrated here). The doctor carrying out the treatment can use the foot-operated switch 34 to switch to the “pure” video image from the camera 26, that is to say he can mask out the numerical display of the patient data 24.

According to one preferred exemplary embodiment, the pure video image, that is to say the video signal 28, is displayed in a standard operating mode of the apparatus 10. In particular, it is also displayed when the video superimposition unit 36 is not being operated, or is not yet being operated, so that it can advantageously be started up quickly in order to carry out an emergency measure. In addition, the apparatus 10 can be used in the conventional manner if the video superimposition unit 36 fails.

The signal converter 48 in the present exemplary embodiment is a VSC 150 Scan Converter from the Extron Electronics Company, USA. The frame grabber cards 38, 40 in the exemplary embodiment which is currently undergoing trials are PC cards of the Falcon 2 type, from the IDS Company.

In contrast to the illustration in the FIGURE, the signal changeover switch 30 can also be integrated in the display screen 32. A control connection is then preferably provided between the video superimposition unit 36 and the screen 32, so that the video superimposition unit 36 can switch between the two operating modes automatically and/or depending on the foot-operated switch 34. The foot-operated switch 34 can also be connected directly to the video superimposition unit 36. In a current exemplary embodiment, the control connection (not illustrated here) is an RS 232 connection between the video superimposition unit 36 and the screen 32.

What is claimed is:

1. A method for displaying medical patient data on a medical display unit having a display screen, the method comprising the steps of:
providing a first video signal which is adapted to be output on the display screen and which contains image data for a first image foreground and a first image background, with the first image foreground representing a first set of medical patient data,
providing a second video signal which is adapted to be output on the display screen and which contains image data representing a second set of medical patient data,
superimposing the first and second video signals to produce a superimposed video signal, with the image data from the first image background being overwritten with image data from the second video signal in the superimposed video signal, and
outputting the superimposed video signal on the display screen.

2. The method of claim 1, wherein the second video signal is provided as an output signal from a camera.

3. The method of claim 2, wherein the second video signal is provided as an output signal from an endoscopic camera.

4. The method of claim 1, wherein the first video signal is provided as an output signal from a measurement data system for recording physiological measurement data of a patient.

5. The method of claim 1, wherein the first and the second video signals are provided in a unified format.

6. The method of claim 5, wherein the first and the second video signals each are provided as an S-VHS signal.

7. The method of claim 1, wherein the superimposed video signal is output on the display screen in a first operating mode, and wherein only the second video signal is output on the display screen in a second operating mode.

8. The method of claim 7, wherein the second operating mode is a standard operating mode, and the first operating mode is selected by choice.

9. The method of claim 1, wherein at least one of the video signals is provided as a digital video signal.

10. An apparatus for displaying medical patient data, comprising
a display unit,
a first image source for producing a first video signal adapted to be output on the display unit, the first video signal containing first image data for a first image foreground and first image background, with the first image foreground representing a first set of medical patient data,
a second image source for producing a second video signal adapted to be output on the display unit, the second video signal containing second image data representing a second set of medical patient data,
a video signal superimposition unit for superimposing the first and second video signals in order to produce a superimposed video signal, with the video signal superimposition unit being designed such that the image data from the first image background is overwritten with image data from the second video signal, and
the display unit being configured to output the superimposed video signal.

11. The apparatus of claim 10, wherein the second image source is a camera.

12. The apparatus of claim 11, wherein the second image source is an endoscopic camera.

13. The apparatus of claim 10, further comprising a measurement data system for recording of physiological measurement data of a patient, with the first image source being a component of the measurement data system.

14. The apparatus of claim 10, further comprising a video signal converter for converting at least one of the video signals to a predetermined signal format.

15. The apparatus of claim 14, wherein the video signal converter is adapted to convert the at least one of the video signals to an S-VHS signal.

16. The apparatus of claim 10, wherein the display unit has at least a first and a second signal input, and has a selection switch for switching between the first and the second signal input, with the superimposed video signal being supplied to the first signal input, and the second video signal being supplied to the second signal input.

17. In an apparatus for displaying medical patient data, the apparatus comprising a display unit, a first image source for producing a first video signal adapted to be output on the display unit, the first video signal containing first image data for a first image foreground and a first image background, with the first image foreground representing a first set of medical patient data, a second image source for producing a second video signal adapted to be output on the display unit, the second video signal containing second image data representing a second set of medical patient data, and a video signal superimposition unit, a computer program comprising program code configured for being executed on the video signal superimposition unit, wherein the program code is designed to superimpose the first and second video signals such that the image data from the first image background is overwritten with image data from the second video signal, thereby producing a superimposed video signal, and wherein the program code is designed to output the superimposed video signal to the display unit.
